(19) United States
(12) Patent Application Publication
(10) Pub. No.: US 2007/0056266 A1
(43) Pub. Date: Mar. 15, 2007

(54) System and method for regenerating a NOx storage and conversion device

(76) Inventor: Eric Kurtz, Cologne (DE)

Correspondence Address: ALLEMAN HALL MCCOY RUSSELL & TUTTLE, LLP, 806 S.W. BROADWAY, SUITE 600, PORTLAND, OR, 97205, US

(21) Appl. No.: 11/226,125

(22) Filed: Sep. 13, 2005

(51) Int. Cl. F02M 25/06; F01N 5/04; F01N 3/00

(52) U.S. Cl. 60/279; 60/289; 60/280; 60/295; 60/286

(57) ABSTRACT

In an apparatus having a diesel engine, a catalytic device in communication with the engine for treating emissions from the engine, and an exhaust gas recirculation (EGR) system having a cooler configured to provide cooled recirculated engine exhaust to an engine intake, and an EGR cooler bypass for providing uncooled recirculated exhaust to the engine intake, a method of regenerating the catalytic device including increasing a flow of uncooled recirculated exhaust provided to the engine intake via the EGR cooler bypass, thereby operating the engine with an increased flow of uncooled recirculated exhaust, and purging the catalytic device of a stored exhaust component while operating the engine with the increased flow of uncooled recirculated exhaust.

### TECHNICAL FIELD

The present application relates to the field of automotive emission control systems and methods.

### BACKGROUND AND SUMMARY

Controlling nitrogen oxide (“NOₓ”) emissions in diesel engines has posed significant challenges to the automotive industry. Several different methods of controlling NOₓ emissions from diesel engines have been proposed. One method is generally known as exhaust gas recirculation (EGR). This method utilizes a conduit to recirculate exhaust gases into the engine intake. The recirculated exhaust gases absorb heat in the combustion chamber, thereby lowering the temperatures within the combustion chamber and lowering the production of NOₓ. A cooler may be provided along the EGR conduit to cool the recirculated exhaust gases and thereby help further lower combustion temperatures.

Another method of controlling NOₓ emissions is through the use of a catalytic device known as a NOₓ trap that is configured to retain NOₓ emissions during lean combustion. A typical NOₓ trap includes an alkaline-earth metal, such as barium, and/or an alkali metal, such as potassium, to which NOₓ adsorbs when the engine is running a lean air/fuel mixture. A rich exhaust may be periodically produced, for example by substantially closing the engine throttle, and/or injecting fuel into the engine exhaust stream, and/or adjusting the camshaft timing, etc. The rich exhaust contains carbon monoxide, hydrogen gas and various hydrocarbons that reduce the NOₓ stored in the trap, thereby decreasing NOₓ emissions and purging the trap.

The combined use of cooled EGR and a NOₓ trap may cooperate to greatly reduce NOₓ emissions. However, throttling the engine to produce a rich exhaust stream for regenerating the NOₓ trap may result in pumping losses and reduced fuel efficiency, even if cooled-recirculated exhaust is provided to the engine intake during the NOₓ trap purge. The inventors herein have realized that improved NOₓ reduction with decreased pumping losses may be achieved by utilizing, in an engine having an EGR system and an EGR cooler bypass, a method of operating an engine including increasing a flow of uncooled recirculated exhaust provided to the engine intake via the bypass, thereby operating the engine with an increased flow of uncooled recirculated exhaust, and purging the catalytic device of a stored exhaust component while operating the engine with the increased flow of uncooled recirculated exhaust.

### BRIEF DESCRIPTION OF THE DRAWINGS

FIG. 1 shows a schematic depiction of an embodiment of a diesel engine.

FIG. 2 shows a flow diagram of an embodiment of a method of operating an engine while purging a catalytic device of a stored exhaust component.

FIG. 3 shows a schematic depiction of another embodiment of a diesel engine.

FIG. 4 shows a schematic depiction of an alternate embodiment of an EGR system having an EGR cooler bypass.

### DETAILED DESCRIPTION OF THE DEPICTED EMBODIMENTS

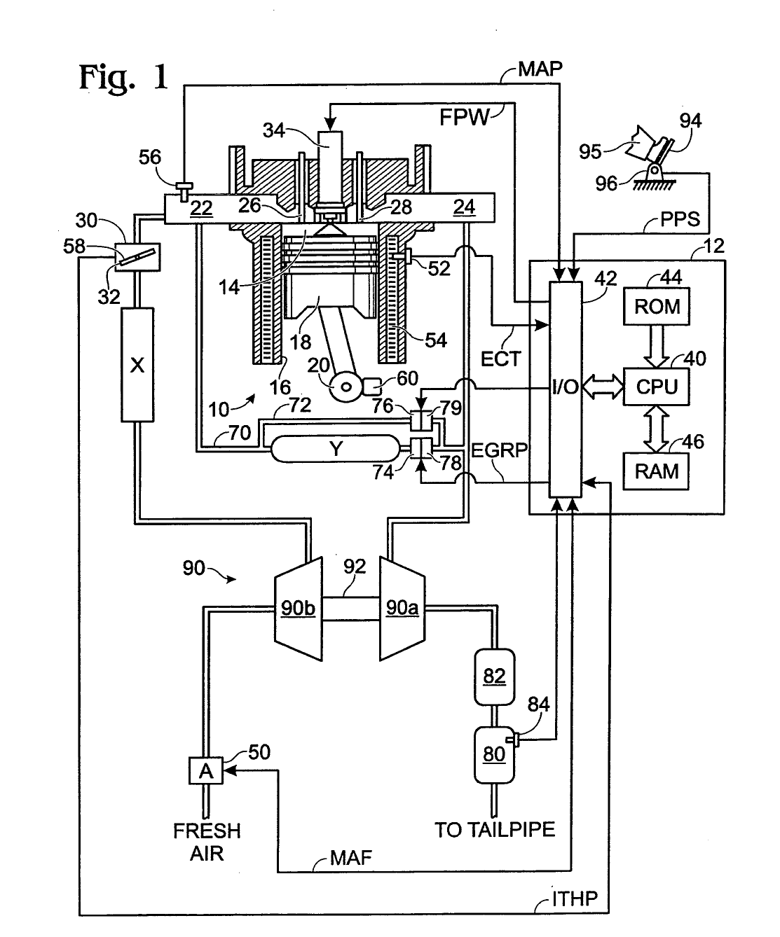

FIG. 1 shows an example of a diesel internal combustion engine system generally at 10. Specifically, internal combustion engine 10, comprising a plurality of cylinders, one cylinder of which is shown in FIG. 1, is controlled by electronic engine controller 12. Engine 10 includes combustion chamber 14 and cylinder walls 16 with piston 18 positioned therein and connected to crankshaft 20. Combustion chamber 14 communicates with an intake manifold 22 and an exhaust manifold 24 via respective intake valve 26 and exhaust valve 28.

Intake manifold 22 communicates with throttle body 30 via throttle plate 32. In one embodiment, an electronically controlled throttle can be used. In one embodiment, the throttle is electronically controlled to periodically, or continuously, maintain a specified vacuum level in intake manifold 22.

Combustion chamber 14 is also shown having fuel injector 34 coupled thereto for delivering fuel in proportion to the pulse width of signal (fpw) from controller 12. Fuel is delivered to fuel injector 34 by a conventional fuel system (not shown) including a fuel tank, fuel pump, and fuel rail (not shown). In the case of direct injection engines, as shown in FIG. 1, a high pressure fuel system is used such as a common rail system. However, there are several other fuel systems that could be used as well, including but not limited to EUI, HEUI, etc.

In the depicted embodiment, controller 12 is a conventional microcomputer, and includes a microprocessor unit 40, input/output ports 42, electronic memory 44, which may be an electronically programmable memory in this particular example, random access memory 46, and a conventional data bus.

Controller 12 receives various signals from sensors coupled to engine 10, including but not limited to: measurements of inducted mass airflow (MAF) from mass airflow sensor 50 coupled to the air filter [A on FIG. 1]; engine coolant temperature (ECT) from temperature sensor 52 coupled to cooling jacket 54; a measurement of manifold pressure (MAP) from manifold pressure sensor 56 coupled to intake manifold 22; a measurement of throttle position (TP) from throttle position sensor 58 coupled to throttle plate 32; and a profile ignition pickup signal (PIP) from Hall effect sensor 60 coupled to crankshaft 20 indicating engine speed.

Engine 10 may include an exhaust gas recirculation (EGR) system to help lower NOₓ and other emissions. The EGR system depicted in FIG. 1 is a high-pressure EGR system in which exhaust gas is delivered to intake manifold 22 by an EGR tube 70 communicating with exhaust manifold 24 at a location upstream of a compressor turbine 90a, and communicating with intake manifold 22 at a location downstream of an intake compressor 90b. An EGR valve assembly 72 is located in EGR tube 70. Stated another way, exhaust gas travels from exhaust manifold 24 first through EGR valve assembly 72, and then to intake manifold 22. EGR valve assembly 72 can then be said to be located upstream the intake manifold. EGR valve assembly 72 is depicted as being located upstream of the EGR cooler, but may also be located at the point where recirculated exhaust is added to the intake manifold, or at any other suitable location along EGR tube 70. An EGR cooler [shown at Y in FIG. 1] is located in EGR tube 70 to cool recirculated exhaust gases before entering the intake manifold. Cooling is typically done using engine water, but and air-to-air heat exchanged may also be used. Furthermore, an EGR cooler bypass 74 provides a path around cooler Y for supplying uncooled recirculated exhaust gas to intake manifold 22, as explained below. EGR cooler bypass 74 also includes a valve assembly 76 for controlling the flow of exhaust gas through EGR cooler bypass 74. While the depicted EGR system is a high-pressure EGR system, it will be appreciated that engine 10 may also include a low-pressure EGR system (not shown) in which the EGR tube is connected to the exhaust system at a location downstream of turbine 90b and to the engine intake at a location upstream of compressor 90b. With a low-pressure EGR system, the EGR cooler bypass may be configured to bypass both the EGR cooler and charge air cooler X.

Pressure sensor 56 provides a measurement of manifold pressure (MAP) to controller 12. EGR valve assembly 72 and bypass valve assembly 76 each has a valve (not shown) for controlling a variable area restriction in EGR tube 70, which thereby controls flow of cooled and uncooled exhaust gas, respectively. EGR valve assembly 72 and bypass valve assembly 76 can variably restrict EGR flow through tube 70 and bypass 74.

Vacuum regulators 78 and 79 are coupled to EGR valve assembly 72 and bypass valve assembly 76, respectively. Vacuum regulators 78 and 79 receive actuation signals from controller 12 for controlling the valve positions of EGR valve assembly 72 and bypass valve assembly 76. In a preferred embodiment, EGR valve assembly 72 and bypass valve assembly 76 are vacuum actuated valves. However, any type of flow control valve or valves may be used such as, for example, an electrical solenoid powered valve or a stepper motor powered valve.

Also, lean NOₓ catalyst or trap 80 and diesel oxidation catalyst 82 are shown coupled in the exhaust path downstream of a compression device 90. Compression device 90 can be a turbocharger or any other such device. The depicted compression device 90 has a turbine 90a coupled in the exhaust manifold 24 and a compressor 90b coupled in the intake manifold 22 via an intercooler [shown at X in FIG. 1], which is typically an air-to-air heat exchanger, but could be water cooled. Turbine 90a is typically coupled to compressor 90b via a drive shaft 92. (This could also be a sequential turbocharger arrangement, single VGT, twin VGTs, or any other arrangement of turbochargers that could be used and could include coolers within the compression device system such as between 2 stages of compression).

Further, controller 12 may receive a measurement of a temperature of NOₓ trap 80 from a temperature sensor 84 associated with NOₓ trap 80. Alternatively, sensor 84 may be positioned such that it provides an indication of exhaust gas temperature, or exhaust manifold temperature. However, placing sensor 84 adjacent to or within NOₓ trap 80 instead of adjacent to or within exhaust manifold 24 may allow the temperature of NOₓ trap 80 to be more accurately determined, as there may be substantial temperature drop in the turbine 90a.

Further, drive pedal 94 is shown along with a driver's foot 95. Pedal position sensor (pps) 96 measures angular position of the driver actuated pedal.

Further, engine 10 may also include exhaust air/fuel ratio sensors (not shown). For example, either a 2-state EGO sensor or a linear UEGO sensor can be used. Either of these can be placed in the exhaust manifold 24, or downstream of devices 80, 82 or 90.

It will be understood that the depicted diesel engine 10 is shown only for the purpose of example, and that the systems and methods described herein may be implemented in or applied to any other suitable engine having any suitable components and/or arrangement of components.

As described above, the concentration of NOₓ emissions produced by engine 10 may be lowered by recirculating exhaust gas into engine 10 via EGR tube 70. The recirculated exhaust gas lowers the combustion temperature in combustion chamber 14, and thereby helps to lower the production of NOₓ. Cooler Y cools the exhaust gas in EGR tube 70, and therefore helps to further reduce combustion temperatures. Any NOₓ that is produced, for example, during acceleration or other transient engine operation where less recirculated exhaust is provided to engine 10, is largely removed from the exhaust by NOₓ trap 80.

However, over time, the NOₓ storage efficiency of NOₓ trap 80 may decrease as a function of the amount of NOₓ stored in the trap. Therefore, to ensure proper functioning of NOₓ trap 80, the trap may be periodically regenerated or purged when the NOₓ storage efficiency drops below a desired level. Purging NOₓ trap 80 may be accomplished by providing a rich exhaust air/fuel mixture to the NOₓ trap. In order to cause diesel engine 10 to provide a rich exhaust air/fuel mixture to NOₓ trap 80, airflow into engine 10 may be restricted via throttle plate 32. Restriction of airflow causes the pressure within intake manifold 22 to decrease, thereby causing piston 18 to do more work when drawing air from intake manifold 22 into combustion chamber 14 than during lean operation. The resulting pumping losses may decrease the fuel economy of engine 10. Further, other methods of producing rich exhaust (that may be used in combination with restriction of the throttle plate), for example, injecting fuel into the exhaust, may further decrease the fuel economy.

To reduce pumping losses, EGR cooler bypass 74 may be used to provide uncooled recirculated exhaust to engine 10 during NOₓ trap regeneration. The use of uncooled EGR offers the advantage that uncooled EGR has a greater volume per unit mass than cooled EGR. Therefore, the use of uncooled EGR allows the charge density within and the airflow through the engine to be reduced compared to the use of cooled EGR, which may help to reduce pumping losses.

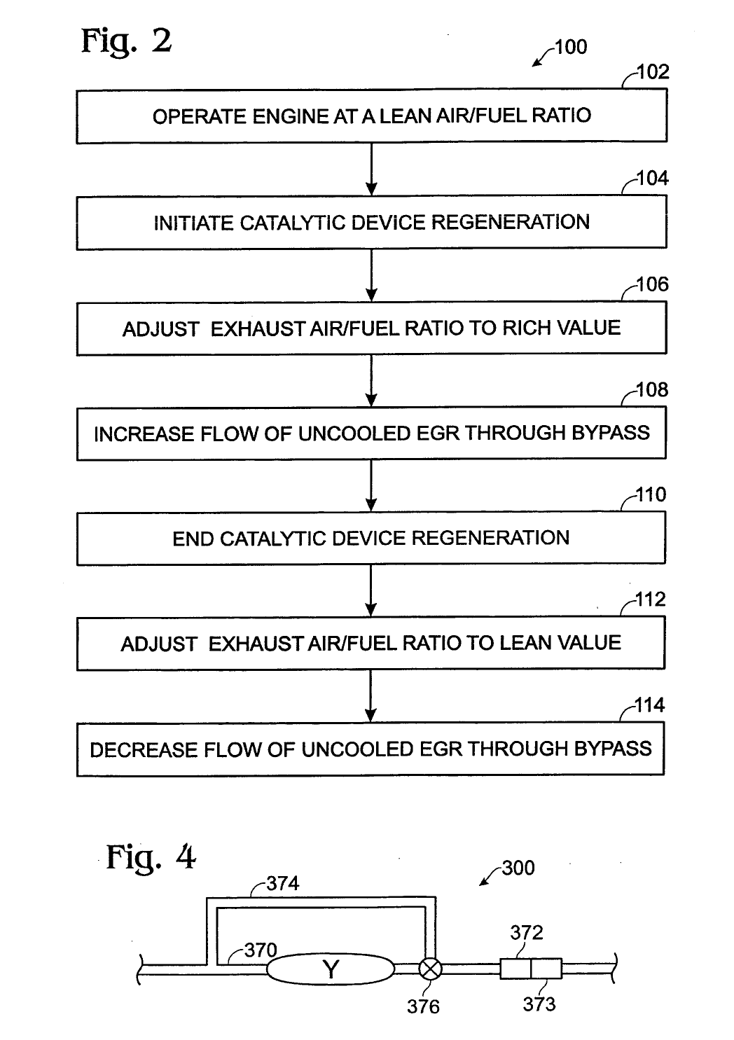

FIG. 2 shows, generally at 100, an embodiment of an exemplary method for operating engine 10 to purge NOₓ trap 80. Method 100 may be performed via the execution of instructions stored in memory 44 and/or 46 memory by controller 12. Method 100 first includes, at 102, operating engine 10 with a lean air/fuel ratio. This step may represent, for example, normal diesel combustion. As lean operation continues, an amount of NOₓ stored in NOₓ trap 80 increases, which may cause a decrease in the storage efficiency of the NOₓ trap. Therefore, method 100 next includes initiating, at 104, a catalytic device purge or regeneration process to purge the NOₓ trap of stored NOₓ. Controller 12 may initiate a purge process, for example, after a passage of a predetermined interval (for example, a time interval, a number of engine cycles, etc.). Alternatively, controller 12 may initiate a purge process after determining that the NOₓ storage efficiency of NOₓ trap 80 has dropped below a predetermined storage efficiency threshold. Controller 12 may determine the NOₓ storage efficiency in any suitable manner. For example, controller 12 may calculate an estimated NOₓ trap storage efficiency from an aging history of the NOₓ trap, from measurements taken by a gas sensor located downstream from NOₓ trap 80 (for example, a NOₓ sensor, UEGO sensor, or other multi-level sensor) compared to an estimated or measured NOₓ concentration in the exhaust upstream of the NOₓ trap, or in any other suitable manner.

Upon initiating a purging process at 104, method 100 next includes adjusting, at 106, an air/fuel ratio of the exhaust from engine 10 to a rich value. This may be accomplished by restricting airflow into engine 10 via throttle plate 58. The restriction of airflow may be accompanied by a late injection of fuel into combustion chamber 14, an injection of fuel into the exhaust, an adjustment of a valve and/or camshaft timing, etc. to help make the exhaust richer. The rich exhaust produced at 106 provides reductants that help reduce stored NOₓ in the NOₓ trap.

Before, during, or after adjusting the exhaust air/fuel ratio to a rich value at 106, method 100 also includes increasing a flow of uncooled EGR through bypass 74, thereby providing uncooled EGR to engine 10 during the NOₓ trap purging process. This may include starting a flow of uncooled EGR through bypass 74 where there was no flow of uncooled EGR was provided to engine 10 during lean operation. Increasing the flow of uncooled EGR through bypass 74 likewise may include increasing an amount of uncooled EGR relative to an amount of cooled EGR provided to engine 10 where both cooled and uncooled EGR were provided to engine 10 during lean operation. Furthermore, increasing a flow of uncooled EGR provided to engine 10 may include shutting off a flow of cooled EGR to the engine, or may include reducing, but not shutting off, a flow of cooled EGR to the engine.

Once it is determined, at 110, that a purging process has reached a sufficient level of completion, method 10 next includes, at 112, adjusting an air/fuel ratio to a lean value (for example, to a value for normal diesel operation), and, at 114, decreasing a flow of cooled EGR through bypass 74. Decreasing a flow of cooled EGR though bypass 74 may include increasing a flow of EGR through EGR tube 70, and/or may include increasing a flow of air into engine 10.

It will be appreciated that the order of the operations shown in FIG. 2 is merely exemplary, and that the various steps of method 100 may be performed in any suitable order. For example, the air/fuel ratio may be adjusted to a lean value before, after, or concurrently with decreasing the flow of cooled EGR through bypass 74. Furthermore, while method 100 indicates that uncooled EGR is supplied to engine 10 for the duration of the NOₓ trap purging process, it will be appreciated that the uncooled EGR may be instead supplied for only a portion of the duration of the NOₓ trap purging process.

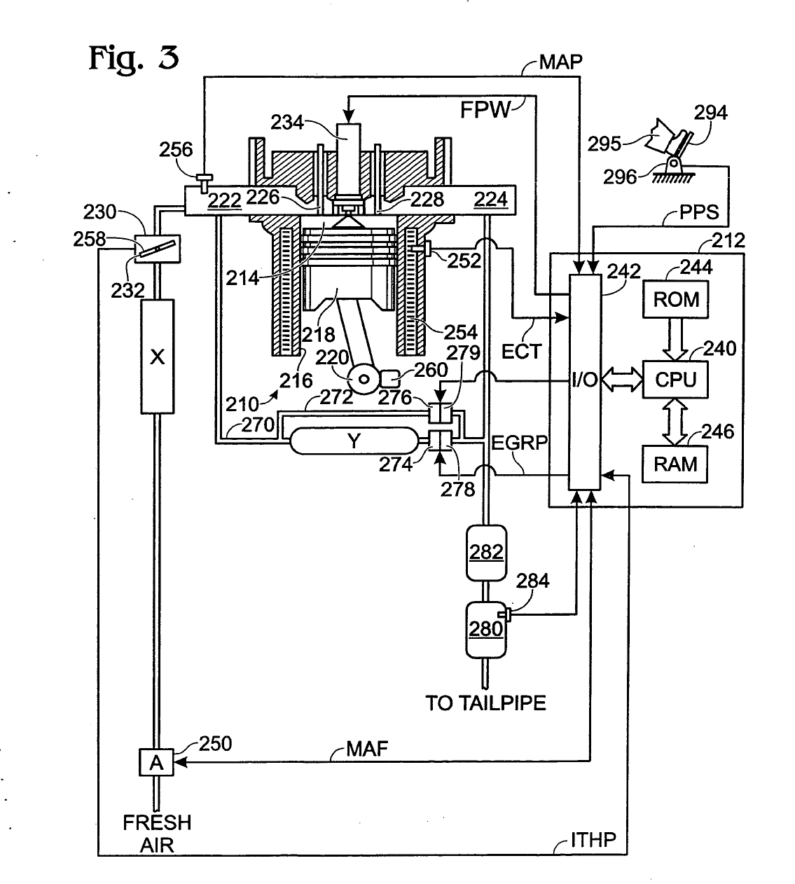

FIG. 3 shows, generally at 200, an alternate embodiment of a diesel engine. Engine 200 includes many similar features as engine 10, and like features in engine 10 and engine 200 are indicated by similar reference numbers. However, unlike engine 10, engine 200 does not include a compression device such as a turbocharger or supercharger. In this embodiment, EGR tube 270 and bypass 274 are connected to the exhaust system at a location upstream of NOₓ trap 280 and diesel oxidation catalyst 282. Alternatively, EGR tube 270 may be connected to the exhaust system at a location downstream of NOₓ trap 280, or between NOₓ trap 280 and filter 282.

FIG. 4 shows, generally at 300, another exemplary embodiment of an EGR system that may be used with method 100. EGR system 300 includes an EGR tube 370, an EGR valve assembly 372 and vacuum regulator 373, a cooler Y disposed along EGR tube 370, an EGR cooler bypass 374 and a valve assembly 376 configured to direct exhaust gas into either EGR tube 370 or bypass 374. The embodiment of FIG. 4 allows valve assembly 372 to be used to turn EGR flow on or off, and valve assembly 376 to be used to adjust relative amounts of cooled and uncooled EGR supplied to the engine intake. While FIG. 4 depicts the EGR valve assemblies 372 and 376 as being upstream of cooler Y, it will be appreciated that either or both valve assemblies may also be positioned downstream of cooler Y, for example, at the location where the EGR tube 370 (and/or bypass tube 374) empties into the engine intake manifold, or at any other suitable location along EGR tube 370. Furthermore, it will be appreciated that the EGR tube and bypass tube and valve configurations shown herein are merely exemplary, and that any other suitable tube, bypass tube, and/or valve configuration may be used.

Although described in the context of NOₓ trap regeneration, it will be appreciated that the concepts disclosed herein may also be applied to other engine operating conditions in which low airflow is desired. Examples include, but are not limited to, diesel particulate filter regeneration (where the particulate filter is heated to burn off trapped particulate matter), NOₓ trap desulfurization, and/or engine and/or catalyst warm-up.

During NOₓ trap regeneration, particulate filter regeneration, and/or NOₓ trap desulfurization, the use of exclusively uncooled EGR may cause the intake gases to exceed temperature limits in the intake manifold. Therefore, one embodiment may include a strategy for regulating the use of the EGR bypass, or an amount of exhaust gas recirculated through the bypass, based on intake manifold temperature measurements such that a threshold is not exceeded. Such a strategy may include decreasing an amount of uncooled EGR provided to the intake when a predetermined intake manifold temperature is exceeded. Note that this temperature issue may be of more concern during particulate filter regeneration and desulfurization since these events may take longer to complete (minutes) compared to rich operation for purging stored NOₓ from the NOₓ trap (seconds), and thereby may increase the risk of intake overheating.

It will be appreciated that the embodiments of systems and methods disclosed herein for reducing pumping losses are exemplary in nature, and that these specific embodiments are not to be considered in a limiting sense, because numerous variations are possible. The subject matter of the present disclosure includes all novel and non-obvious combinations and subcombinations of the various EGR tube, EGR valve, EGR cooler bypass configurations, systems and methods for reducing pumping losses, and other features, functions, and/or properties disclosed herein. The following claims particularly point out certain combinations and subcombinations regarded as novel and nonobvious. These claims may refer to “an” element or “a first” element or the equivalent thereof. Such claims should be understood to include incorporation of one or more such elements, neither requiring nor excluding two or more such elements. Other combinations and subcombinations of the EGR tube, EGR valve, EGR cooler bypass configurations, systems and methods for reducing pumping losses, and/or other features, functions, elements, and/or properties may be claimed through amendment of the present claims or through presentation of new claims in this or a related application. Such claims, whether broader, narrower, equal, or different in scope to the original claims, also are regarded as included within the subject matter of the present disclosure.

What is claimed is:

1. In an apparatus having a diesel engine, a catalytic device in communication with the engine for treating emissions from the engine, and an exhaust gas recirculation (EGR) system having a cooler configured to provide cooled recirculated engine exhaust to an engine intake and an EGR cooler bypass for providing uncooled recirculated exhaust to the engine intake, a method of regenerating the catalytic device, comprising:
increasing a flow of uncooled recirculated exhaust provided to the engine intake via the EGR cooler bypass, thereby operating the engine with an increased flow of uncooled recirculated exhaust; and
purging the catalytic device of a stored exhaust component while operating the engine with the increased flow of uncooled recirculated exhaust.

2. The method of claim 1, wherein increasing a flow of uncooled recirculated exhaust provided to the engine intake includes operating the engine to produce a rich exhaust air/fuel ratio.

3. The method of claim 2, wherein operating the engine to produce a rich exhaust air/fuel ratio includes reducing an airflow into the engine via a throttle plate while increasing the flow of uncooled recirculated exhaust provided to the engine intake.

4. The method of claim 1, further comprising reducing a flow of cooled recirculated exhaust provided to the engine intake while purging the catalytic device.

5. The method of claim 4, wherein reducing a flow of recirculated exhaust provided to the engine intake includes shutting off the flow of cooled recirculated exhaust provided to the engine intake.

6. The method of claim 1, further comprising decreasing a flow of uncooled recirculated exhaust provided to the engine intake after purging the catalytic device.

7. The method of claim 6, wherein decreasing the flow of uncooled recirculated exhaust provided to the engine intake after purging the catalytic device includes shutting off the flow of uncooled recirculated exhaust after purging the catalytic device.

8. The method of claim 1, wherein the engine includes a turbocharging system, and wherein the EGR system is a high pressure EGR system.

9. The method of claim 1, wherein the catalytic device is a NOₓ trap, and wherein the stored exhaust component is NOₓ.

10. The method of claim 1, wherein the catalytic device is a NOₓ trap, and wherein the stored exhaust component is sulfur.

11. The method of claim 1, wherein the catalytic device is a particulate filter, and wherein the stored exhaust component is particulate matter.

12. The method of claim 1, further comprising monitoring a temperature of the engine intake, and reducing the flow of uncooled recirculated exhaust if the temperature of the engine intake exceeds a predetermined temperature threshold.

13. In an apparatus having a diesel engine, a NOₓ trap in communication with the engine for treating emissions from the engine, and an exhaust recirculation (EGR) system having a cooler configured to provide cooled recirculated engine exhaust to an engine intake and an EGR cooler bypass for providing uncooled recirculated exhaust to the engine intake, a method of operating the engine, comprising:
providing cooled recirculated exhaust to the engine intake while operating the engine at a lean air/fuel ratio;
operating the engine to produce a rich exhaust air/fuel ratio to purge the NOₓ trap of stored NOₓ emissions; and
providing at least some uncooled recirculated exhaust to the engine intake via the EGR cooler bypass while operating the engine at the rich exhaust air/fuel ratio.

14. The method of claim 13, wherein providing at least some uncooled recirculated exhaust to the engine intake while operating the engine to produce a rich exhaust air/fuel ratio includes providing uncooled recirculated exhaust to the exclusion of cooled recirculated exhaust.

15. The method of claim 13, wherein providing at least some uncooled recirculated exhaust to the engine intake includes providing a mixture of cooled and uncooled recirculated exhaust to the engine intake.

16. The method of claim 13, wherein providing cooled recirculated exhaust to the engine intake includes providing a mixture of cooled and uncooled exhaust to the engine intake.

17. The method of claim 13, further comprising restricting an airflow into the engine via a throttle plate while providing at least some uncooled recirculated exhaust to the engine intake.

18. The method of claim 13, further comprising monitoring a temperature of the engine intake, and reducing an amount of uncooled recirculated exhaust provided to the engine intake if the temperature of the engine intake exceeds a predetermined temperature threshold.

19. An apparatus, comprising:
a diesel engine;
a catalytic device in communication with the engine for treating emissions from the engine;
an exhaust gas recirculation (EGR) system having a cooler configured to provide cooled recirculated engine exhaust to an engine intake and an EGR cooler bypass for providing uncooled recirculated exhaust to the engine intake; and
a controller configured to control a purging of the catalytic device of a stored compound by reducing an amount of air provided to the engine and increasing a flow of uncooled recirculated exhaust provided to the engine via the EGR cooler bypass during a purging process.

20. The apparatus of claim 19, wherein the controller is configured to restrict an airflow into the engine via a throttle plate while purging the catalytic device and while providing an increased flow of uncooled recirculated exhaust to the engine.

21. The apparatus of claim 19, wherein the controller is configured to provide a decreased flow of cooled recirculated engine exhaust to the engine intake while providing an increased flow of uncooled recirculated exhaust to the engine intake during a purging process.

22. The apparatus of claim 21, wherein the controller is configured to provide an increased flow of uncooled recirculated exhaust to the exclusion of a flow of cooled recirculated exhaust during a purging process.

23. The apparatus of claim 19, wherein the controller is further configured to provide a decreased flow of uncooled recirculated exhaust to the engine intake while providing an increased flow of cooled recirculated exhaust to the engine intake after completing a purging process.

24. The apparatus of claim 23, wherein the controller is configured to provide an increased flow of cooled recirculated exhaust to the exclusion of a flow of uncooled recirculated exhaust to the engine intake after completing a purging process.

25. The apparatus of claim 19, wherein the catalytic device is a NOₓ trap, and wherein the stored exhaust component is NOₓ.

26. The apparatus of claim 19, wherein the catalytic device is a NOₓ trap, and wherein the stored exhaust component is sulfur.

27. The apparatus of claim 19, wherein the catalytic device is a particulate filter, and wherein the stored exhaust component is particulate matter.

28. The method of claim 19, wherein the controller is configured to monitor a temperature of the engine intake, and to reduce the flow of uncooled recirculated exhaust if the temperature of the engine intake exceeds a predetermined temperature threshold.
